(19) United States
(12) Patent Application Publication
(10) Pub. No.: US 2004/0181994 A1
(43) Pub. Date: Sep. 23, 2004

(54) Fishhook line connector and method

(76) Inventor: Gerald R. Morrow, Vancouver, WA (US)

Correspondence Address: OLSON AND OLSON, 5412 SE FOSTER ROAD, PORTLAND, OR, 97206, US

(21) Appl. No.: 10/804,948

(22) Filed: Mar. 19, 2004

Related U.S. Application Data
(60) Provisional application No. 60/456,679, filed on Mar. 21, 2003.

(51) Int. Cl. A01K 85/00; A01K 1/00

(52) U.S. Cl. 43/42.36

(57) ABSTRACT

The fishhook of this invention has a resilient open loop at the end of the fishhook shank opposite the barb and has a terminal end portion flared outwardly from the shank of the fishhook, to facilitate entry and securing of a fishing line into the open loop by resilient flexing. The end portion of a fishing line then is wrapped around the resilient section of the open loop and the confronting fishhook shank and the terminal portion of the line then is drawn through the flared end of the open loop, to secure the line against unwrapping. The open loop may have diverse shapes. An adapter has an open loop and an adjacent spiral coil configured for threading through the eyelet and around the shank of a conventional fishhook to secure the adapter to the fishhook shank adjacent the eyelet.

The application claims the benefit of Provisional application Serial No. 60/456,679, filed 21 March 2003.

### BACKGROUND OF THE INVENTION

This invention relates to fishhooks, and more particularly to a fishhook provided with a connector that enables the attachment of a leader or other fishing line with speed and facility.

Fishhooks presently in use by professional and sports fishermen incorporate at the end of the fishhook opposite the barb an eyelet through which a fishing line is threaded and then tied off to secure the connection. About one minute is required for this procedure, and more time is expended when visibility and other conditions are impaired. Since many fishhooks generally are tried in sequence until one is found that best attracts the local fish, the accumulated time involved in removing each fishhook and attaching another represents lost fishing time as well as causing frustration and anxiety for the fishermen.

### SUMMARY OF THE INVENTION

This invention provides a fishhook in which the conventional closed eyelet at the end of a fishhook opposite the barb or hook is replaced with an open loop and a flared opening for slidably guiding a leader or other fishing line into the open loop. An adapter also is provided with the same open loop at one end and a plurality of spaced spiral coils at the opposite end for positive attachment to the eyelet end of a conventional fishhook for conversion to the configuration of the present invention.

It is the principal objective of this invention to provide a fishhook that overcomes the limitations and disadvantages of prior fishhooks.

Another objective of this invention is to provide a fishhook with a connector that avoids the requirement of threading a line through an eyelet.

Still another objective of this invention is the provision of a fishhook with the connector that affords attachment of a line in less than 10 seconds.

A further objective of this invention is to provide a fishhook of the class described that affords attachment of a line in the absence of visibility.

A further objective of this invention is the provision of an adapter by which a conventional fishhook is converted to provide the open loop configuration of this invention.

The foregoing and other objects and advantages of this invention will appear from the following detailed description, taken in connection with the accompanying drawings of preferred embodiments.

### BRIEF DESCRIPTION OF THE DRAWINGS

FIG. 1 is a plan view on an enlarged scale of a fishhook provided with a first embodiment of a fishing line connector end portion embodying the features of this invention.

FIGS. 2, 3 and 4 are enlarged fragmentary plan views showing a sequence of manipulations of a fishing line resulting in securing the line to the fishhook connector end portion of FIG. 1.

FIG. 5 is an enlarged fragmentary plan view of a second embodiment of a fishing line connector end portion of a fishhook embodying the features of this invention.

FIGS. 6, 7 and 8 are fragmentary plan views showing a sequence of manipulation of a fishing line resulting in securing the line to the connector of FIG. 5.

FIG. 9 is an enlarged fragmentary plan view of a third embodiment of a fishing line connector end portion of a fishhook embodying the features of this invention.

FIG. 10 is a fragmentary plan view showing the manipulations of a fishing line resulting in securing the line to the fishing line connector end portion of the fishhook of FIG. 9.

FIG. 11 is an enlarged fragmentary plan view of a fishing line connector adapter configured to form a substantially rigid extension of a conventional fishhook and incorporating the fishing line connector end portion illustrated in FIG. 1.

### DESCRIPTION OF THE PREFERRED EMBODIMENTS

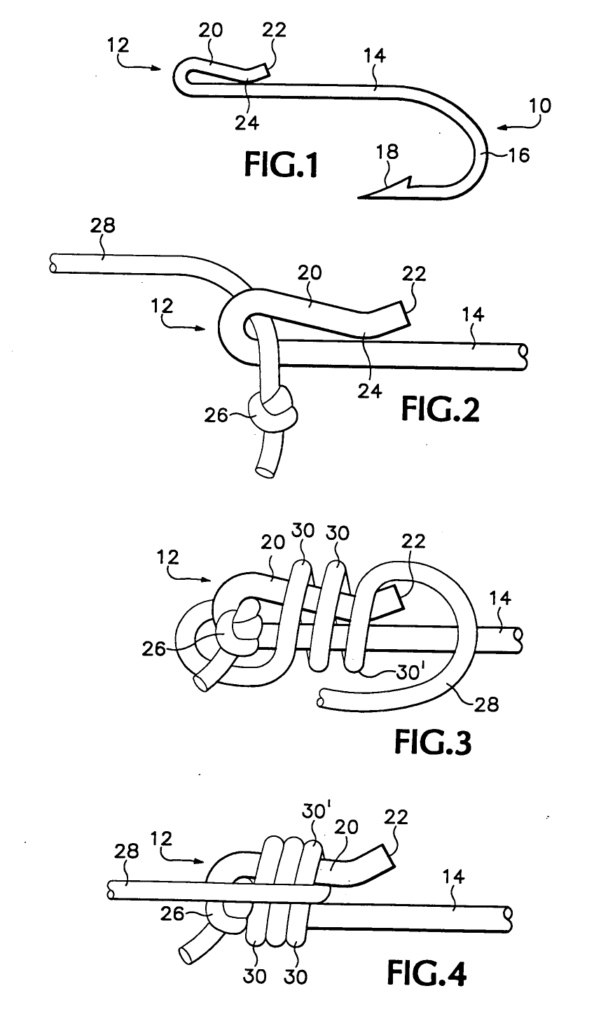

Referring first to the embodiment shown in FIG. 1, the fishhook includes a front end portion 10 and a rear end portion 12 interconnected by an intermediate shank portion 14. The front end portion 10 includes a hook 16 terminating in a barb 18. The rear end portion 12 is provided with a reversely bent resilient section 20 which terminates in an outwardly bent end section 22. The juncture 24 between the sections 20 and 22 is positioned in abutment with, or closely adjacent, the intermediate shank portion 14 of the fishhook. The outwardly bent section 22 facilitates the entry of fishing line into the space between the resilient section 20 and shank portion 14 by resilient flexing of the bent section 20 to allow passage of the fishing line inwardly past the juncture 24.

Attachment of a fishing line 28 to the fishhook of FIG. 1 is achieved by manipulating the fishing line through the sequence of steps illustrated in FIGS. 2-4. First, a knot 26 (FIG. 2) preferably is formed in the line adjacent one end and the line is fed transversely into the space between the outwardly bent section 22 and the intermediate shank portion 14 of the fishhook. The line is pushed past the juncture 24 by the resilient flexing of the reversely bent section 20, and the fishing line is pulled through to bring the knot 26 into abutment with the bent section 20 and intermediate shank portion 14.

If the knot 26 is not provided, the extending end portion of fishing line may be cut off, if desired. The maximum space between the shank portion 14 and resilient section 20 preferably is slightly smaller than the diameter of the fishing line, to provide frictional resistance to movement of the line through said space. The fishing line is drawn forwardly, past the position of the knot 26 and wrapped about the resilient section 20 and intermdiate shank portion 14, as illustrated in FIG. 3. The wrapping may be a single wrapping, or it may be multiple wrappings, as illustrated by the two complete wrappings 30 in FIGS. 3 and 4.

After the illustrated second wrapping 30, or any other desired final wrapping, the third partial wrapping 30′ of the fishing line is looped around the outwardly bent section 22 and into the V-shaped space between the section 22 and shank portion 14, and the line pulled rearwardly across the coils of wrappings after it has been snapped through the juncture 24 and into the space between the shank portion 14 and resilient section 20. The fishing line wrappings thus are tightened about the rear portion 12 of the fishhook and the line is secured frictionally to the fishhook between the shank portion 14 and resilient section 20 rearwardly of the juncture 24. This securement is enhanced by the clamping force exerted by the tightened coils 30, 30′ of wrappings which keep the juncture 24 reduced to less than the diameter of the fishing line 68.

It is to be noted that the attachment of the fishhook to the fishing line 28 requires no time consuming threading of line through conventional fishhook eyelets and the subsequent tying of the line to secure the attachment. These manipulations involve considerable time to execute, and the time is extended proportionately as visibility and other conditions deteriorate. On the other hand, attachment of the fishhook of this invention can be accomplished without any visual aid, but rather merely by finger touch. It has been determined that whereas the threading and tying of a fishing line to the eyelet of a conventional fishhook requires at least about 45 seconds, under optimum conditions, the attachment of a fishing line to a fishhook of the configuration shown in FIGS. 1-4 requires but about 5-10 seconds, without the aid of sight.

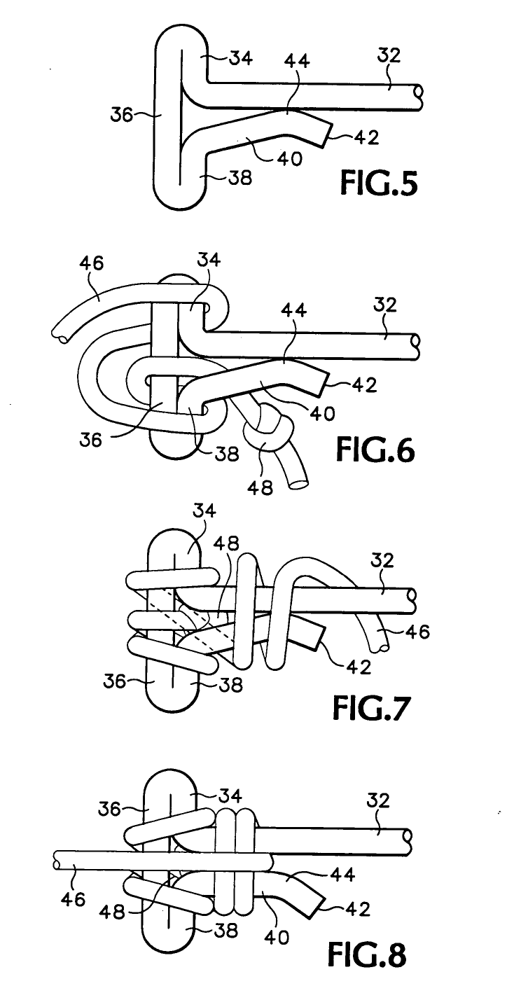

Referring now to the embodiment shown in FIGS. 5-8, the reversely bent section 20 of FIG. 1 is replaced by a T-shaped configuration produced by bending a rear end shank portion 32 of a fishhook to form outwardly extending anchor segment 34, the transverse segment 36 extending perpendicular to the longitudinal axis of shank portion 32, the inwardly extending anchor segment 38 opposite segment 34, the forwardly projecting resilient section 40 and outwardly bent section 42 with juncture 44. The sections 40, 42 and 44 function in the same manner as sections 20, 22 and 24 in FIGS. 1-4.

Fishing line 46 is secured to the fishhook of FIG. 5 by the manipulations shown in FIGS. 6-8. A knot 48 preferably is formed in the end portion of the fishing line 46 (FIG. 6) and the line snapped through the juncture 44 into the space between shank portion 32 and resilient section 40. The line is pulled through the space to bring the knot, if provided, into abutment with the fishhook. The fishing line then is looped around the transverse segment 36 and forwardly under segments 36 and 38 and resilient section 40. The line then is looped rearwardly over segment 38 and the adjacent portion of transverse segment 36, and then transversely across the longitudinal axis of shank portion 32 (FIG. 7) and around the sections 34 and 36. The line then is drawn forwardly under the resilient portion 40 and looped about the sections 40 and 32. The partial second loop then is drawn rearwardly through the flared entrance gap between the outwardly bent section 42 and shank portion 32 and snapped through the juncture 44. The line then is pulled rearwardly of the fishhook (FIG. 8) to tighten the coils and frictionally secure the line to the fishhook. As in FIG. 4, the line is secured against loosening by the frictional grip exerted on it by the resilient section 40 inwardly of the juncture 44.

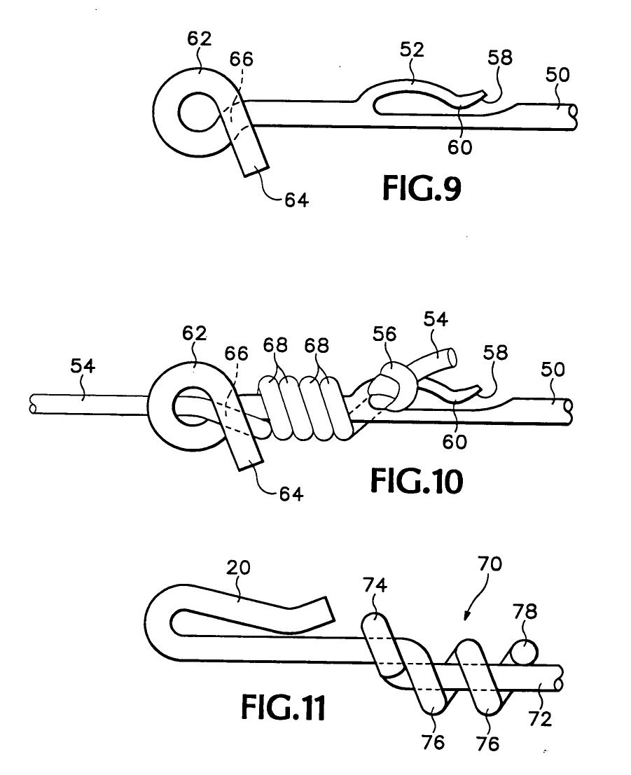

In the embodiment illustrated in FIGS. 9 and 10, the intermediate shank portion 50 of the fishhook is sliced longitudinally to peel back a small longitudinal section 52 which is extended angularly outward to form a V-shaped notch between it and the confronting shank portion 50. The section 52 may be re-shaped in the manner of section 20 of FIG. 1, for anchoring an end of the fishing line 54 preferably at a preformed knot 56. The sharp tip end of section 52 may be cut off to prevent cutting a person. The section 52 also may be shaped to form an outwardly bent section 58 at juncture 60, in the manner of junctures 24 and 44 previously described. The terminal end portion of the fishhook is formed as an open loop 62 with the terminal end section 64 of the loop forming a juncture 66 abutting or spaced closely adjacent the shank portion 50 to allow the line 54 to be snapped through into the center of the loop.

The fishing line 54 is secured to the fishhook by snapping it through the juncture 60 and drawing it through the space within the section 52 until the knot 56 is anchored against the fishhook. The line then is coiled, once or multiple times (four coils 68 in FIG. 10) about the shank portion 50, and then snapped through the confined space at the juncture 66 and into the central opening of the loop 62. The frictional grip on the line at the juncture 66 inhibits loosening of the line at the coils.

The foregoing description identifies novel fishhook attaching configurations for the shank end of fishhooks opposite the barb end. FIG. 11 illustrates an adapter 70 by which the line attaching configurations of this invention may be integrated with a conventional fishhook in which the shank 72 of the fishhook terminates in a line-receiving closed or substantially closed eyelet 74. The eyelet preferably is disposed at an angle to the shank, although it may be a straight extension of it. Both angled and straight eyelets are available commercially.

The adapter of this invention includes a line-attaching section configured, as illustrated, as the reversely bent section 20 of the embodiment of FIG. 1. It is to be understood, of course, that the configurations of FIGS. 5 and 9, as well as others that embody the invention, may be substituted for that of FIG. 1.

The adapter includes a connector section extending from the line-attaching section 20 and is formed as a spiral of spaced apart loops 76 terminating at an open loop 78 which is configured to frictionally grip the shank 72. The loops 76 receive the shank in closely spaced relation.

The adapter is attached to a conventional fishhook by threading the end of the open loop 78, and then the spiral loops 76, through the opening of eyelet 74 of the fishhook and coiling the loops about the shank 72 of the fishhook by rotating the adapter or fishhook one relative to the other. The frictional grip of the open loop 78 and the closely fitting spiral loops 76 on the fishhook shank 72 secures the adapter as a substantially rigid extension of the fishhook.

Disconnection of the adapter from the fishhook is achieved simply by rotating either the fishhook or the adapter in the direction to unthread the fishhook eyelet 74 from the coils 76 and 78.

It will be apparent to those skilled in the art that various changes and modifications may be made in the size, shape, type, number and arrangement of components described hereinbefore, and the maneuvers in attaching and detaching the fishing line from the fishhook. For example, the junctures 24, 44 and 60 may be replaced with the configuration of the junctures 66, and vice versa. The directions of wrapping the fishing line in connecting it to a fishhook may be modified, as desired. The connectors of this invention will accommodate the mounting of conventional and well-known egg loops, if desired. These and other changes may be made without departing from the spirit of this invention.

I claim:

1. A fishhook, comprising:
a) an elongated shank having a hook member at one end, and
b) a reversely bent portion of said shank adjacent the opposite end of the hook member forming an inner space and a flared open end portion for receiving a fishing line member transversely therethrough and into said inner space.

2. The fishhook of claim 1 wherein the flared open end portion is resilient and is configured for enabling substantially closing of the space between said flared open end portion and the adjacent shank portion of the fishhook for retaining a fishing line within said space.

3. The fishhook of claim 1 wherein the resilient flared open end portion is configured for wrapping a portion of a fishing line adjacent the hook member around the reversely bent portion to secure the fishing line therein.

4. The fishhook of claim 1 wherein the reversely bent end portion includes laterally projecting reversely bent anchor segments for wrapping a portion of a fishing line around said segments.

5. The fishhook of claim 1 wherein the fishhook includes an eyelet at the end of the shank opposite the hook member, and an adapter member having a flared open end portion and a spiral coil section adjacent the opposite end, the spiral coil section being configured for reception through the eyelet and then encircling the adjacent portion of the shank for attachment to the fishhook.

6. The fishhook of claim 1 wherein the flared open end portion is resilient and is configured for enabling closing of the space between said flared open end portion and the adjacent shank portion of the fishhook for retaining a fishing line within said space, the resilient flared open end portion being configured for wrapping a portion of a fishing line adjacent the hook member around the reversely bent portion to secure the fishing line therein.

7. The method of securing a fishing line to the fishhook of claim 1, comprising:
a) passing an end portion of the fishing line through said flared opening and into said space,
b) wrapping the fishing line around said reversely bent portion and the confronting portion of the shank, and
c) passing the fishing line adjacent said wrapped portion through said flared open end portion of the hook member to secure the wrapped portion to the fishhook.

8. The method of securing a fishing line to the fishhook of claim 1, comprising:
a) tying a knot in the fishing line adjacent one end thereof,
b) drawing the knot in the fishing line into abutment with the reversely bent portion,
c) wrapping the fishing line around said reversely bent portion and the confronting portion of the shank, and
d) passing the fishing line adjacent said wrapped portion through said flared open end portion of the hook member to secure the wrapped portion to the fishhook.

9. The method of securing a fishing line to the fishhook of claim 4, comprising:
a) passing an end portion of the fishing line through said flared opening and into said space,
b) wrapping the fishing line around one of said laterally projecting reversely bent anchor segments,
c) wrapping the fishing line around the other of said laterally projecting reversely bent anchor segments,
d) wrapping the fishing line around said reversely bent portion and the confronting portion of the shank, and
e) passing the fishing line adjacent said wrapped portion through said flared open end portion of the hook member to secure the wrapped portion to the fishhook.
